(19) United States
(12) Patent Application Publication
(10) Pub. No.: US 2004/0066451 A1
(43) Pub. Date: Apr. 8, 2004

(54) Airborne delivered video surveillance system

(76) Inventor: Michael Schroth, Mullica Hill, NJ (US)

Correspondence Address: Sonya C. Harris, PO Box 2607, Fairfax, VA, 22031, US

(21) Appl. No.: 10/265,332

(22) Filed: Oct. 7, 2002

(51) Int. Cl. H04N 7/18; H04N 9/47

(52) U.S. Cl. 348/144; 348/151

(57) ABSTRACT

The present invention features a covert surveillance system employing airborne delivery assets for obtaining photographic information. Exterior, high-resolution video surveillance of towns, military facilities, factories, hideouts and other areas of interest are made possible with real-time mode monitoring. The system comprises a compact surveillance assembly that may be embellished with a variety of camouflage schemes to mesh with the natural environment of deployment. The surveillance assembly is made from a sufficiently high-density material and is equipped with a penetrating nose cone configured for embedding into the earth's surface. The assembly comprises impact shock absorption means, camera means, transmitter/receiver means, a control unit and on-site power means. After being made airborne, the surveillance assemblies may be deployed to target sites by either remote guidance means (e.g., laser and GPS)

### BACKGROUND OF THE INVENTION

1. Field of the Invention

The present invention relates to a covert surveillance system and, more particularly, a video surveillance system having an apparatus that can be deployed by air to target sites of interest for real-time video information.

2. Discussion of the Prior Art

The prior art is replete with devices used for the purposes of video surveillance. The U.S. Patent to Martin, et al., (U.S. Pat. No. 5,384,588) issued Jan. 24, 1995, teaches of a system for achieving perspective-corrected views at a site remote from the created image. U.S. Pat. No. 6,375,370 issued to Wesselink, et al., on Apr. 23, 2002, is concerned with temporary surveillance for sites under construction or temporary building structures. Herein, Wesselink discloses a portable video system that is designed to be easily assembled and tamper-proof.

Hollenbeck, et al., (U.S. Pat. No. 5,886,738, issued Mar. 23, 1999, teaches of a compact video surveillance system that is used for viewing images from a remote location capable of full 360 degree pan, tilt, zoom, focus and iris control from a remote location via a radio transmitter and receiver. The U.S. Patent to Sergeant, et al., U.S. Pat. No. 5,517,236, issued May 14, 1996, teaches of a video surveillance system that employs the use of several remote surveillance units. Each of the units have a video camera mounted inside a dome housing that is panned and/or tilted to a desired orientation within the dome. Video signals from the remote surveillance units are received by a video switcher/multiplexer that synchronizes the video signals from the remote units.

None of these patents either teaches or suggests a video surveillance system that is specially encased for airborne delivery. As will be seen in greater detail hereinafter, the present invention involves all of the video surveillance features such as camera adjustments such as pan and tilt, and image adjustments while providing covert, real-time video information.

### SUMMARY OF THE INVENTION

The present invention features a covert surveillance system employing airborne delivery assets for obtaining photographic information. Exterior, high-resolution video surveillance of towns, military facilities, factories, hideouts and other areas of interest are made possible with real-time mode monitoring. The system comprises a compact surveillance assembly that may be embellished with a variety of camouflage schemes to mesh with the natural environment of deployment. The surveillance assembly is made from a sufficiently high-density material and is equipped with a penetrating nose cone configured for embedding into the earth's surface. The assembly comprises impact shock absorption means, camera means, transmitter/receiver means, a control unit and on-site power means. After being made airborne, the surveillance assemblies may be deployed to target sites by either remote guidance means (e.g., laser and GPS) or by aerial means such as airplanes, helicopters or the sort.

It is therefore an object of the invention to provide a surveillance system that may be delivered from above ground altitudes.

It is another object of the invention to provide an airborne delivered surveillance system that provides real-time video surveillance.

It is another object of the invention to provide an airborne delivered surveillance system that provides real-time video surveillance with laser targeting.

It is also an object of the invention to provide an airborne delivered surveillance system that provides real-time video surveillance that can be remotely controlled.

It is a further object of the invention to provide an airborne delivered surveillance system that may be guided to a destination with remote guiding means such as laser guidance and global position systems (GPS) employing satellite guidance.

It is an additional object of the invention to provide a an airborne delivered surveillance system that provides real-time video surveillance that is covert in presentation by employing camouflaged encasings that mesh with the environmental surroundings.

These and other objects, features and advantages will be more apparent from a study of the enclosed text and the appended drawings.

### BRIEF DESCRIPTION OF THE DRAWINGS

A complete understanding of the present invention may be obtained by reference to the accompanying drawings, when taken in conjunction with the detail description thereof and in which:

FIG. 1 is a front view of the Remote Surveillance Assembly (RSA) 10, in accordance with a preferred embodiment of the present invention.

FIGS. 2A-2C are diagrammatic views of a preferred airborne delivery method, in accordance with the present invention.

FIG. 3 is a front perspective of the ground impact mechanism, in accordance with the present invention.

FIG. 4A is perspective view of the camera means in accordance with the present invention.

FIG. 4B is a front view of the camera compartment in accordance with a preferred embodiment of the present invention.

FIG. 5 is a diagram depicting remote operation of the Remote Surveillance Assembly using satellite signal transmissions.

FIG. 6 is a diagrammatic view of an alternate airborne deployment method for short-range deployment, in accordance with the present invention.

FIG. 7 is a diagrammatic view of an alternate airborne deployment method for long-range deployment using G.P.S. satellite navigation, in accordance with the present invention.

FIGS. 8A and 8B are diagrams of alternate embodiments of the Remote Surveillance Assembly with solar energy means.

### DESCRIPTION OF THE PREFERRED EMBODIMENT

This disclosure of the invention is submitted in furtherance of the constitutional purposes of the U.S. Patent Laws “to promote the progress of science and useful arts” (Article 1, Section 8).

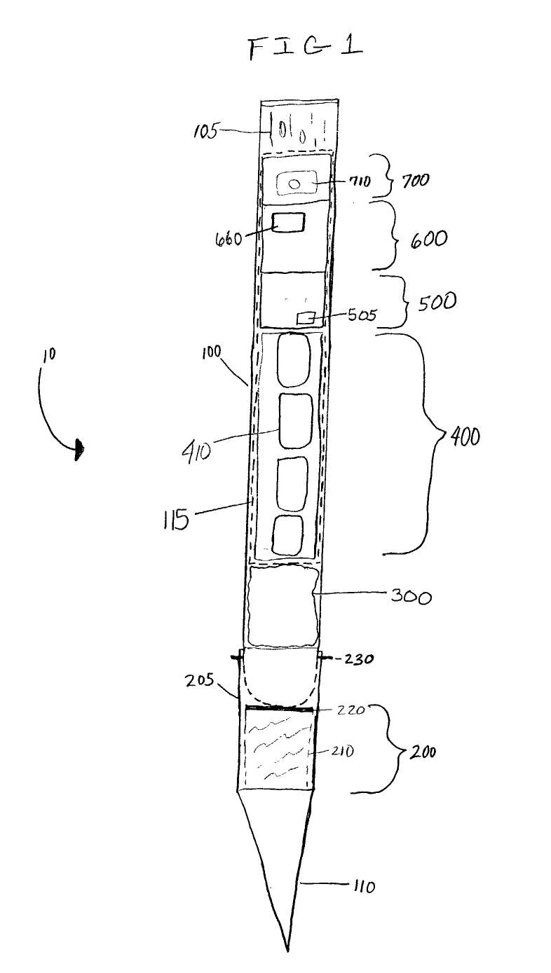

Generally speaking this invention relates to a surveillance system that may be delivered from above ground. The surveillance system provides instant information and relays the information from a remote surveillance assembly (RSA) 10, as shown in FIG. 1. The RSA 10 covertly houses surveillance equipment and is comprised of a rigid, highly dense material that is substantially impact resistant. The RSA 10 is preferably configured as a telescoping pipe-within-a pipe structure with a first upper pipe 100 being received by a second lower pipe 200 to assist in minimizing damaging impact forces.

The upper pipe 100 serves as the housing structure for containing the surveillance equipment. As diagrammatically illustrated in FIG. 1, upper pipe 100, has a proximal end and a distal end, and houses the camera compartment 700, the transmitter and receiving (T/R) unit 600, the controller compartment 500, the battery compartment 400, as well as an airbag assembly 300.

All of the surveillance equipment is further contained within a cage assembly 115 that rests on top of airbag assembly 300. The airbag assembly 300 is connected to the proximal end of said upper pipe 100 and exterior to said cage assembly 115. Upon contact with the ground surface, airbag assembly 300 automatically inflates in approximately 2 to 3 ms within the inner diameter of upper pipe 100. The inflated airbag 300 provides a cushion to the cage assembly 115 and all of the internal components housed therein from impact forces.

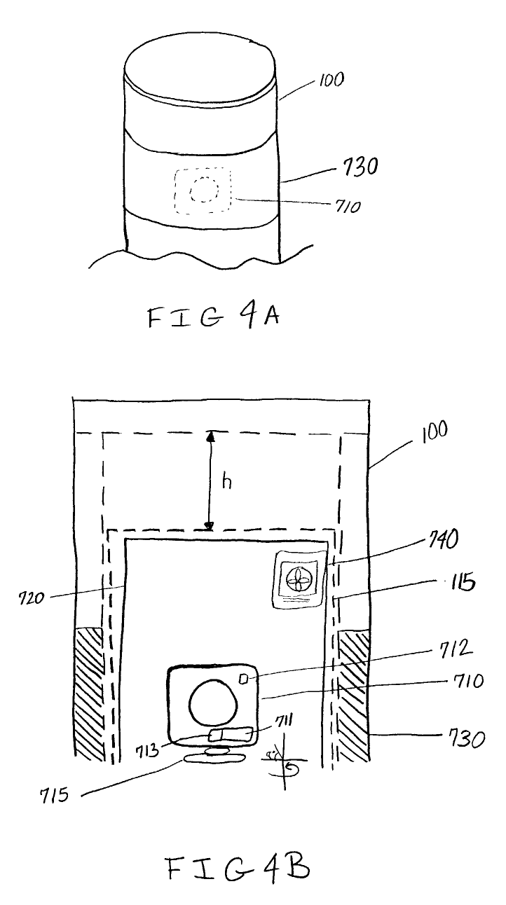

As can be seen in FIG. 4B, a spaced distance of height h, is provided between the uppermost portion of the interior of upper pipe 100 and cage assembly 115. This allotted space h provides displacement room for the cage assembly 115 during inflation of the airbag 300 upon impact. After impact, the airbag assembly deflates and the cage assembly 115 resettles. Conceivably, further cushioning devices, such as springs, may be provided within space h to absorb impact forces. For instance, coil springs (and the like) or a cushion material (fabric or expanded foam) may be adapted either on the ceiling of the upper pipe 100 interior, or the roof of the cage assembly's 115 exterior.

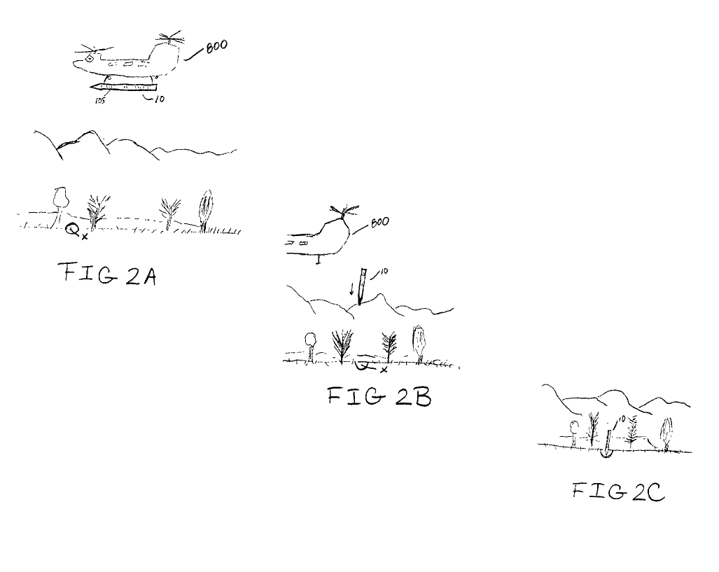

In a preferred embodiment, the method of deployment of RSA 10 is via an airborne delivery vehicle (ADV) 800. FIG. 2A illustrates such a deployment wherein RSA 10 is made airborne and cargoed toward a target site X. As the ADV 800 approaches the target site X, the RSA 10 is delivered in a vertical direction relative to the earth's surface. Depending on how the RSA's 10 are secured to, or within an ADV 800, the RSA's 10 may be delivered singularly or in scores, as needed.

Airborne delivery vehicles 800 may be adapted to singularly accommodate the RSA 10 or a plurality thereof in the cargo area. Depending on how the cargo area is utilized for internally securing RSA's 10, aircraft, such as a C-130 Hercules, for example, (or similar aircraft) can hold scores at a time. A helicopter, such as the Chinook CH47 can also be employed to handle several RSA's simultaneously secured to the underside.

Upon release, each RSA 10 will immediately orient itself to a vertical direction relative to the earth's surface as seen in FIG. 2B. This is principally accomplished by the very heavy, dense and aerodynamically shaped nose cone 110 (FIG. 1). The nose cone 110 is constructed of a mass and weight that significantly surpasses the combined weight of the upper pipe 100 and all its internal components.

Both upper and lower pipes 100 and 200, respectively, can be constructed of commercially available standard, heavy wall carbon steel piping. In a preferred embodiment, six-inch carbon steel Schedule 160 pipe could be used having an outside diameter of 6.625 inches with a wall thickness of approximately three-quarter's of an inch. However, it is to be appreciated that the dimensions (i.e., diameter, length, etc.), of pipes 100 and 200, may be larger or smaller without departing from the scope of the invention. The heavy wall thickness is required to provide an adequate amount of weight for optimum earth penetration.

A six-inch diameter pipe of this type falls in the range of a weight of approximately 1500 pounds, at about 45 pounds per foot. The total length of pipes 100 and 200 will vary depending on such factors as cumulative equipment packaging, signal transmission specifics, ADV 800 cargo capability, and the terrain of the target area. A rocky or mountainous terrain would require a different penetration depth than a softer grassy soil terrain.

In addition to its dense metallic structure, nose cone 110 is aerodynamically designed of a conical shape. The length and width of the nose cone 110 is dimensioned in accordance with the exact density of the material selected during manufacture. The RSA 10 is configured to rapidly descend at a rate determined by the ejection height from the ADV 800. These combined specifics of the nose cone 110 are capable of penetrating a wide variety of earth materials, and soil types, including various types of rocky surfaces.

The nose cone 110 will enter the earth's surface at the target site X and drive to an appropriate depth to hold the RSA 10 securely in its final position. FIG. 2C shows the airborne delivered RSA 10 embedded in the earth's surface at the target site X. Although shown in a conical tapered shape, the nose cone 110 may take on other shapes and/or may include beveling indentations that may aide in wedging into the ground surfaces.

The pipes 100 and 200 are constructed of heavy wall carbon steel, as described above. The exterior of these pipes 100 and 200 can be painted or embossed with camouflaging indicia 105 that blends with the natural environment of the target site X. Thereby, from a distance, the RSA 10 would not appear as an uncommon site. The upper and lower pipes 100 and 200 may also be embellished with camouflaging objects such as vines, branches, and the like (not shown). However, such objects are designed of lightweight materials and placed so as not to affect the necessary aerodynamic properties of RSA 10.

The RSA's 10 internal components housed within cage assembly 115 are protected from the sudden impact force via several mechanisms. One such mechanism is the telescoping pipe-within-a-pipe configuration of upper pipe 100 and lower pipe 200 (FIGS. 1 & 3), which inherently aids in shock absorption. In addition, impact mechanism 205 provides impact resistance wherein lower pipe 200 utilizes a fluid-shock absorbing means.

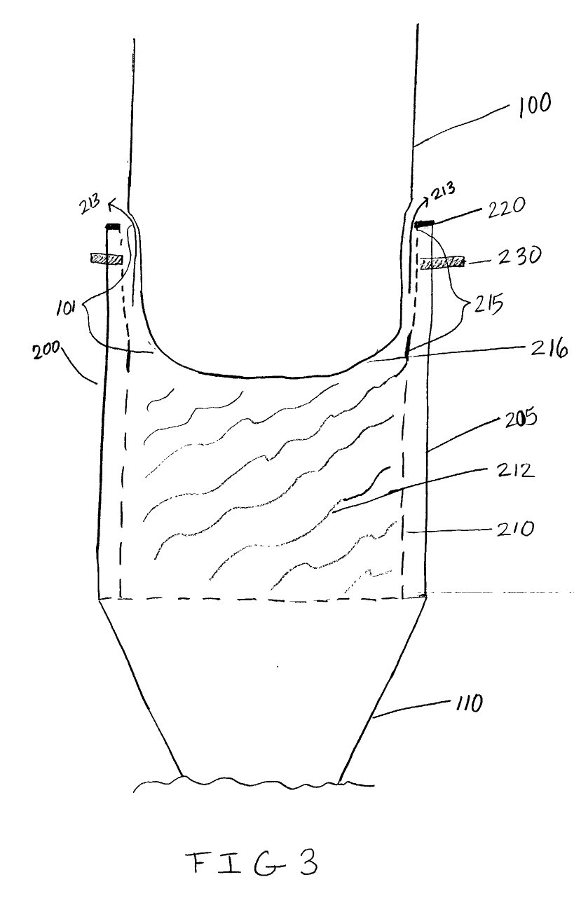

Lower pipe 100 is equipped with an impact mechanism 205 which consists of an inner chamber 210, a lateral fluid seal 220 sealingly spanning a horizontal plane of the inner chamber, a series of breakaway bolts 230, and a recess 215, as shown in FIG. 3. Upon impact, a series of breakaway bolts 230 would immediately shear, allowing the upper pipe 100 to break seal 220. Lower pipe 205 has a hollow interior chamber 210. The seal 220 closes the hollow chamber 210 off to sealingly enclose fluid 212. In addition to a mechanical sealing, a standard weld bead can be welded into place, or an epoxy applied, all to result in the desired temporary watertight sealing. Upon impact, and breaking off of the bolts 230, the upper pipe 100 then enters through to the interior chamber 210 breaking the seal 220 there between.

The proximal end of upper pipe 100 has a section 101 with a diameter d₁ smaller than the diameter d₂ of the remaining length of upper pipe 100. This smaller diameter d₁ graduates in width resulting in a tapered section 101. The fluid 212 contained within chamber 210 is pressurized and of a controlled volume such that liquid or gas escapes through the escape flow channel created by recess 215 and the tapered proximal end 101 at a specified slow and controlled rate, thus dampening delivery impact forces. Fluid 212 escapes in the direction of arrow 213. The fluid may be a liquid (such as water, for example) or a gas (such as nitrogen, for example). If a gas is used, then the gas would be introduced into chamber 210 after the seal 220 is applied. The gas can be introduced through a common valve fitting into the lower pipe 200.

For the purposes of this disclosure, the preferred method of surveillance is video imaging. The video compartment 700, as shown in FIGS. 4A and 4B, shows the video equipment in a diagrammatic fashion. Camera 710 may be equipped with a laser targeting means 712 that transmits a laser beam onto a target for obtaining the best possible imaging. The camera 710 is configured with a pan/tilt mechanism 715 for omni directional movement. It will be appreciated by one of ordinary skill in the art that the camera may be controlled remotely or automatically via a processor contained within the camera compartment 700 or within the controller compartment 500. The laser targeting means 712 may also be used to maintain a beam on a subject until an aircraft or other military vehicle arrives for further action.

The camera means 710 can be equipped with auto-tracking capability that allows the camera to automatically lock onto and follow a preprogrammed subject. This may be accomplished by digitally analyzing pixels to precisely track the subject of interest. The pan/tilt mechanism 715 can be maintained in an automatic mode to keep the subject in a frame and also zoom to ensure that the size of subject remains constant.

The upper pipe 100 has a window 730 that traverses the entire perimeter of the pipe 100 in a desired image receiving area to allow for 360 degree imaging by the camera means 710. The length of the window 730 is of a sufficient height to correspond with the size of the lens aperture of the camera 710. The window 730 may be of a thick acrylic material that is shatterproof and inherently resistant to external forces. It may be appreciated that window 730 may be made of any other suitable transparent material, such as glass, without departing from the scope of the invention. It is to be further appreciated that the window 730 may be a continuous structure or may be intermittent forming viewpoints around the entire perimeter of upper pipe 200 without departing from the scope of the invention.

The camera means 710 may include a camera control unit 711 which comprises an image transmitter for transmitting images to a remote receiver, camera control circuitry for communicating with CPU 510 and for controlling the direction (i.e., pan and tilt), zoom, focus, and aperture of the camera, a radio receiver for receiving remotely transmitted camera control information and for delivering the information to the camera control circuitry. Along with controlling direction, the camera control unit 711 may control image adjustments. It is of essence to the video surveillance to provide cameras capable of automatically adjusting certain operational parameters such as focus setting, shutter speed, color adjustments and the like.

For instance, in natural lighted environments, it is necessary to equalize or balance the levels of red, green, and blue in a video signal relative to the detected levels of such colors, in accordance with the spectrum of the light in the observed areas. Sunlight, for example, has a spectrum that approximates a 5,500K blackbody; hence the spectrum of reflected light from a white object will exhibit a peak in the green region. This is referred to the color temperature of an object. Herein, color filters may be used to compensate or equalize the response when color film is used to account for various color temperatures.

Alternatively, in electronic imaging systems, which may be employed, it is common to provide a variable gain device, known as a white balance system, to equalize the response of an electronic imaging device in accordance with the prevailing color temperature. Automatic white balance systems may be employed wherein the levels of compensation applied to the color component of a video image are continuously adjusted in response to the measured color content of the image.

The camera compartment 700 may also house a climate control unit 740. Climate control unit 740 provides built-in thermostatically controlled camera operation allowing cold weather operation and prevention of condensation. The climate control unit 740 may be equipped with a temperature gauging means (e.g., thermometer), a cooling unit, a heater and a fan to maintain an appropriate climate for optimum operation of the camera means 710. The climate control unit 740 will also aid in defogging and defrosting the window 730 which may occur due to external weather conditions.

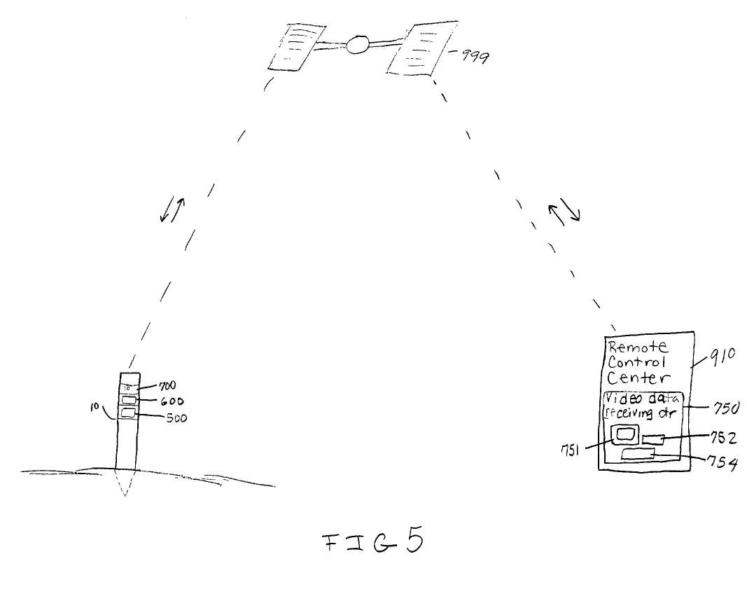

In addition, the camera control unit 711 may include a power supply 713 that provides power to all of the devices within the control unit 711. The power supply 713 is electrically connected to the battery compartment 400. The camera means 710 receives images and transmits them via an image transmitter (not shown) and relays them to a remote video data receiving means 750 (FIG. 5). The remote video data receiving means 750 may include a display means 751, such as a monitor, as well as a video recording means 752 to record images received by the image receiver. The camera means 710 can also be equipped with an automatic video motion detection system (not shown). These operations performed on the RSA 10 may be controlled via a CPU 505 of controller means 500.

As best illustrated in FIG. 5, remote operation of the camera means 710 is as follows. When a user in a location that is remote from the RSA 10 wishes to view images from the camera means 710, the operator at the remote control center (RCC) 910 may transmit control operations via a remote control transmitter 754. One of ordinary skill in the art will appreciate that a number of different wireless communication systems may be used to transmit and receive data signals (shown in FIGS. 5-7 as dashed lines).

As shown, wireless signals are transmitted to a satellite device 999 and then subsequently relayed to the transmitter/receiver unit 600 of the RSA 10. It is envisioned that the satellite 999 may be a member of the Global Positioning System (GPS) space vehicles fleet. The nominal GPS operational constellations consist of 24 satellites that orbit earth in 12 hours. GPS is funded by and controlled by the U.S. Department of Defense (DOD).

GPS provides specially coded satellite signals that can be processed in a GPS receiver 660. Authorized users with cryptographic equipment and keys and specially equipped receivers, such as receiver 660 may use the GPS for signal transfer as well as the Precise Positioning Service (PPS), described further below.

The Master Control facility for the GPS is located at a U.S. Air Force base control to the United States. The Master Control facility measures signals from the space vehicles that are incorporated into orbital models for each satellite 999. The models compute precise orbital data (ephemeris) in which the space vehicles then send subsets of orbital ephemeris data to the GPS receivers 660 over radio signals.

Along with the transmission and reception of long-range radio signals, the GPS system may be used to compute position, velocity and time in a virtually real-time mode. The GPS may be employed for the Precise Positioning Service for long-range deployment, in lieu of an ADV 800. GPS receivers convert space vehicle radio signals into position, velocity and time estimates. Four satellites are required to compute the four dimensions X, Y, Z and Time. Therefore, the GPS receiver 660 may be used for navigation, positioning and time dissemination of RSA 10.

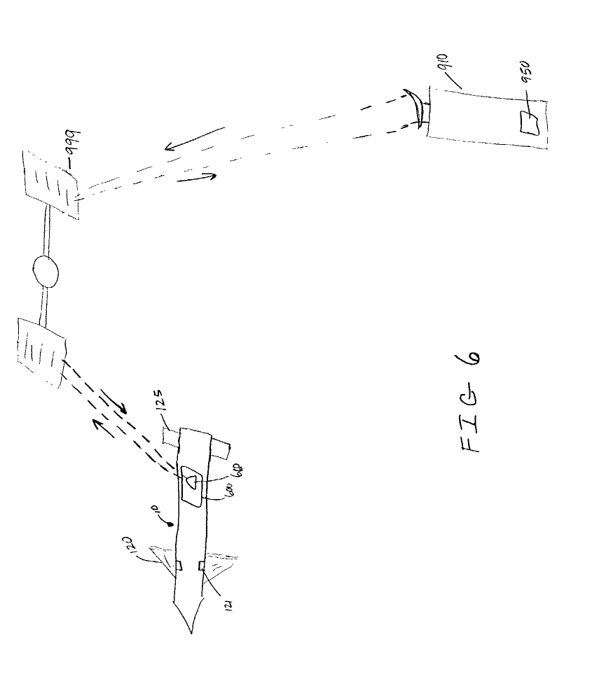

As pictorially illustrated by FIG. 6, precise positioning of the RSA 10 is possible using GPS receiver 660 at reference target locations providing corrections and relative positioning data. Herein, the RSU 10 may be initially launched and then guided via PPS. Intended targeting signals can be relayed from a flight command control unit 950 housed in the RCC 910. The flight control unit 910 then relays the flight path signals to service vehicle satellite 999 that in turn communicates with GPS receiver 660 housed in the T/R unit 600 of RSU 10.

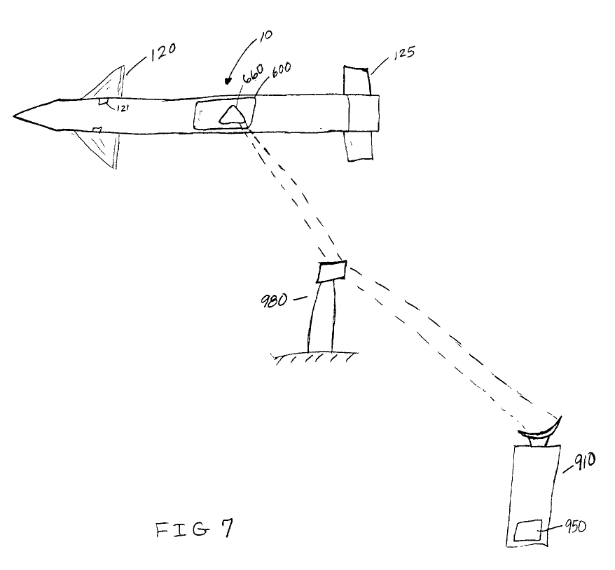

One of ordinary skill in the art would appreciate that the RSA 10 may also be laser guided to a target site X. As shown in FIG. 7, flight guidance signals may be directed from flight control command unit 950 of RCC 910. These signals may be transmitted to a relay tower 980, or a series thereof, and subsequently relayed to receiver 610. Receiver 610 is in constant communication with flight control processor 520 housed within the controller compartment 500.

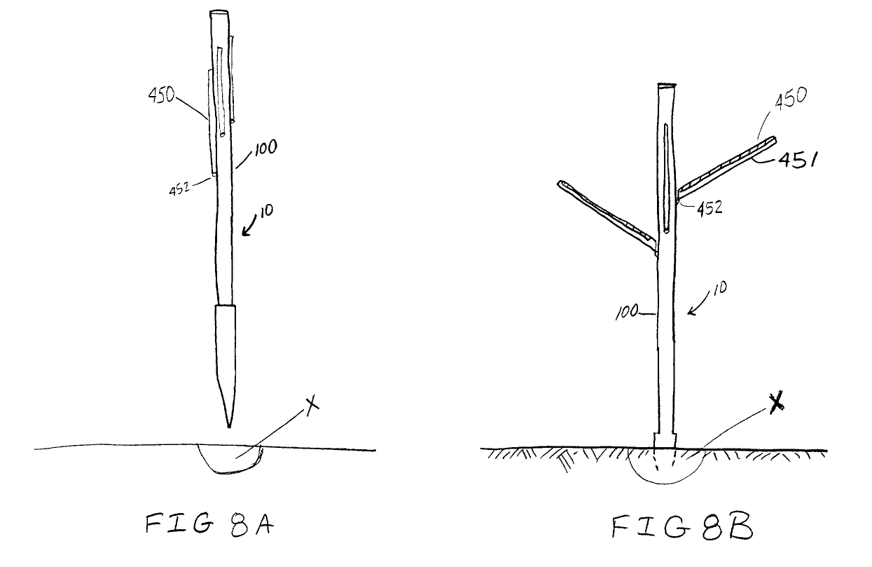

The RSA 10 may be made airborne by launching devices known to those of ordinary skill in the art, and flight guided thereafter as described above in view of FIGS. 7 and 8. These launching devices known in the art can provide propulsion and lift to take RSA 10 to the appropriate altitude for gliding and guidance to the target location X.

In such instances, the RSA 10 may be equipped with wings 120 and/or fins 125 to allow for rudimentary flight control. The wings 120 may be removably attached to lower pipe 200 with breakaway bolts (not shown). When the RSA 10 impacts the ground, the breakaway bolts will shear, causing the wings 120 to fall off the lower pipe 200. Similarly, fins 125 may also be secured to the upper housing 100 with breakaway bolts (not shown). The wings 120 may be attached to the lower pipe 100 by standard servomotors 121 that allow bi-directional movement.

The power compartment 400 (FIG. 1) is adapted to provide in-house electrical power for all of the equipment of the RSA 10. A series of low wattage, long life, and rechargeable batteries 410 may be contained within the power compartment 400 for providing constant, direct current electricity sized to provide adequate energy to all of the operating equipment.

The battery cells 410 may be arranged in series stacked on top of one another attached by a redundant conductor harness or bus (not shown). The battery cells 410 are designed for extreme rough handling and may be composed of rugged deep-cycle, nickel-cadmium or nickel-metal hydride. Battery cells 410 should have a minimum of one thousand hours (over 40 days) of continuous operation without recharging.

In another embodiment, the RSA 10 may be adapted with a photoelectric, solar power system, as illustrated in FIGS. 8A and 8B. The solar power system may comprise a series of photovoltaic devices 450, also known as solar cells. These photovoltaic devices 450 may be secured to a number of long tube branch structures 451 attached to the RSA 10 by self-deploying hinges 452 to the upper pipe 100.

The long tube branch structures 451 may be attached in a vertical fashion such that during delivery, they are in a closed state flush with the upper pipe as shown in FIG. 8A. After delivery to the desired target site X, the long tube branch structures 451 move to an open state via hinges 452 to align the photovoltaic cells 450 toward the sky for absorption of the sun's energy. Photovoltaic cells 450 are constructed of solid-state semiconductor devices that would contain no moving parts that would require maintenance.

In conventional solar cell installations, most of the cells are oriented to the south for maximum sun exposure. In the instant case of the RSA 10, this would not be readily possible. Therefore the long tube branch structures 451 are deployed in a 360-degree manner (via hinges 452) thereby providing maximum sun exposure throughout daylight hours to at least two branches at any time.

The long tube branch structures 451 are also configured to have a specific angle of inclination relative the longitudinal axis of the RSA 10, to take advantage of the target area's X latitude and season to absorb the maximum amount of solar energy. Photovoltaic cells 450 are employed to charge and/or recharge the battery cells 410 during daylight hours in continuous operation and supply energy for the non-daylight hours. Photovoltaic cells 450 may be attached by serial or parallel wiring harness to a charge controller unit (not shown) to prevent overcharging and/or deep discharge of the batteries 410.

Since other modifications and changes varied to fit a particular operating requirements and environment will be apparent to those skilled in the art, the invention is not considered limited to the example chosen for purposes of disclosure, and covers all changes and modifications which do not constitute a departure from the true spirit and scope of the invention.

For example, as a preferred embodiment, the surveillance device discussed throughout the invention employed the use of video cameras. However, it is to be appreciated that the RSA's 10 may alternatively or additionally include, for example, still photography cameras, infrared sensors, audio sensors, time lapses or digital cameras without departing from the scope of the invention.

Furthermore, the surveillance equipment may comprise multiple cameras in conjunction with multiplexers, as well known in the art. In addition, it is contemplated that the system may include other external equipment such as lights, satellite transmission devices, and equipment enabling cell phone applications.

As to the housing structure, the pipe housings 100 and 205 may include further multiple telescoping portions. The height of the RSA 10 may vary depending on the elevation of the environment and height most suitable for observing a desired range of the target site X. The invention has been described as having two telescoping pipes, however more telescoping sections may be added without departing from the scope of the invention.

The possible uses of the RSA's 10 are countless. For example, the RSA's can be utilized as advanced “eyes” for scout/recon troops in a battlefield. RSA's can be deployed in front of troops before entering an area of interest. Video signals can be transferred or relayed directly to the troops on the ground. Real time information would allow ground troops to deploy in a safer and more effective manner. Deploying an RSA 10 to a specific landing zone prior to dropping off troops would allow safety analysis of the area and help prevent casualties. This same information can be relayed during Battlefield Damage Assessment. The RSA's 10 may be employed to provide visual (or otherwise) data if a battlefield during and after battle.

Having thus described the invention, what is desired to be protected by Letters Patent is presented in the subsequent appended claims.

What is claimed is:

1. An airborne delivered surveillance system for covertly providing real-time mode information from a targeted site of interest to a remote location, said system comprising:
a) a remote surveillance assembly, said assembly having
1) a hollow upper pipe for housing equipment, said upper pipe having a proximal and a distal end and being formed of a very heavy, substantially dense and rugged material, said upper pipe having
surveillance means for obtaining reconnaissance data,
power supply means,
a first impact resistance means, and
cage means for containing said surveillance means and said power supply; and
2) a hollow lower pipe, said lower pipe made of a very heavy and rugged material, said lower pipe further having
a second impact resistance means and
a substantially dense and heavy nose cone, said nose cone being formed with such a mass and density so as to be of a weight substantially exceeding that of the upper pipe, including the housed equipment;
said lower pipe being adapted to matingly receive said upper pipe,
said assembly further having temporary fastening means for matingly coupling said pipes; and
b) remote control means, located at a remote location from said surveillence assembly, for communicating with said surveillance means.

2. The airborne delivered surveillance system as in claim 1, wherein,
said surveillance means comprises
real-time information acquisition means for acquiring instantaneous reconnaissance data;
communication means for providing communication between said surveillance equipment and said remote control means; and
controller means for controlling operation parameters of said surveillance means.

3. The airborne delivered surveillance system as in claim 2, wherein,
said first impact resistance means is an airbag assembly,
said airbag assembly being connected to the proximal end of said upper pipe and exterior to said cage assembly and adapted to inflate upon ground contact to cushion impact forces when said airborne delivered surveillance system contacts the earth's surface.

4. The airborne delivered surveillance system as in claim 3 wherein
said second impact resistance means, of said lower pipe, comprises
a fluid compartment, said fluid compartment having an upper portion sealed by a temporary mechanical sealing means for temporarily sealing fluid within said fluid compartment, and
said temporary mechanical sealing means forming a temporary barrier between said upper pipe and said lower pipe.

5. The airborne delivered surveillance system of claim 4
wherein said temporary mechanical sealing means comprises a lateral seal closing off a longitudinal plane of said fluid compartment,
wherein said temporary fastening means comprises a series of breakaway bolts, said breakaway bolts adapted to shear upon contact with the earth's surface and allowing said proximal end of the upper pipe to break through the temporary mechanical sealing means and thus enter the fluid compartment.

6. The airborne delivered surveillance system of claim 5 wherein said fluid compartment has a recess formed in the upper portion thereof; and
said proximal end of said upper pipe having a tapered portion;
said tapered portion and said recess together forming a fluid escape channel.

7. The airborne delivered surveillance system of claim 6 wherein said fluid is comprised of a gas of a specific density and volume to allow a controlled rate of escape from said fluid escape channel.

8. The airborne delivered surveillance system of claim 6 wherein said fluid comprised is of a liquid of a specific density and volume to allow a controlled rate of escape from said fluid escape channel.

9. The airborne delivered surveillance system of claim 6 wherein
said real time information acquisition means comprises a camera means for producing imaging data; and wherein said camera means being housed in a camera compartment.

10. The airborne delivered surveillance system of claim 9 wherein
said upper pipe has window means formed along the perimeter therein for allowing said camera means to obtain substantially a 360° imaging ability; and
wherein said camera compartment further contains climate control means for regulating temperature and thus maintaining optimum operating conditions for said camera means.

11. The airborne delivered surveillance system of claim 10 wherein
said upper and lower pipes have camouflaging indicia embossed thereon to mesh with the natural environment of the targeted site of interest.

12. The airborne delivered surveillance system of claim 11 wherein
said power supply means comprises a series of battery cells for providing direct, continuous operation.

13. The airborne delivered surveillance system of claim 12 wherein
said power supply means further comprises solar power means for obtaining energy from the sun.

14. The airborne delivered surveillance system of claim 13 wherein
said solar power means comprises an array of photovoltaic cells electrically connected to said battery cells for providing energy to said battery cells.

15. The airborne delivered surveillance system of claim 14 wherein
said controller means has flight guidance means for receiving remote signals from said remote control means to automatically direct said remote surveillance assembly to the target area of interest.

16. The airborne delivered surveillance system of claim 15 wherein
said remote surveillance assembly has wings removably coupled to said lower pipe for assisting in flight guidance to the target area of interest.

17. The airborne delivered surveillance system of claim 16 wherein
said remote surveillance assembly has fins removably coupled to said upper pipe for assisting in flight guidance to the target area of interest.

18. The airborne delivered surveillance system of claim 17 wherein
said wings and fins are adapted to break off upon impact with the earth's surface.

19. The airborne delivered surveillance system of claim 9 wherein
said communication means further comprises a transmitter and receiver unit for receiving remote signals for overall operation of said surveillance system.

20. The airborne delivered surveillance system of claim 19 wherein
said transmitter and receiver unit comprises a global positioning device for satellite signal transfer of navigation and operational information.
